(19) United States
(12) Patent Application Publication
(10) Pub. No.: US 2015/0235792 A1
(43) Pub. Date: Aug. 20, 2015

(54) ELECTROMAGNETIC RELAY

(71) Applicant: FUJITSU COMPONENT LIMITED, Tokyo (JP)

(72) Inventors: Katsuyuki TAKAHASHI, Tokyo (JP); Yoshinori KURATA, Tokyo (JP); Daishi KITAJIMA, Tokyo (JP)

(73) Assignee: FUJITSU COMPONENT LIMITED, Tokyo (JP)

(21) Appl. No.: 14/609,506

(22) Filed: Jan. 30, 2015

(30) Foreign Application Priority Data
Feb. 19, 2014 (JP) 2014-029784

(51) Int. Cl. H01H 50/56

(52) U.S. Cl. CPC H01H 50/56

(57) ABSTRACT

An electromagnetic relay includes: an electromagnet; a twin contact set that includes first twin contacts provided on a first movable spring, and second twin contacts that are provided on a first fixed contact plate and disposed opposite to the first twin contacts; a single contact set that includes a first single contact provided on a second movable spring, and a second single contact that is provided on a second fixed contact plate and disposed opposite to the first single contact; and a card that moves in response to excitation or non-excitation of the electromagnet, and moves the first and the second movable springs simultaneously with the movement of the card.

### CROSS-REFERENCE TO RELATED APPLICATION

This application is based upon and claims the benefit of priority of the prior Japanese Patent Application No. 2014-029784 filed on Feb. 19, 2014, the entire contents of which are incorporated herein by reference.

### FIELD

A certain aspect of the embodiments is related to an electromagnetic relay.

### BACKGROUND

Conventionally, there has been known a relay including a contact spring and a fixed contact plate (see Japanese Laid-open Patent Publication No. 5-242753). In the relay, a tip of the contact spring is divided into two parts, and twin contacts are provided on the divided two parts, respectively. A single contact is provided on a base end of the contact spring. Fixed contacts are provided on positions on the fixed contact plate opposite to the twin contacts and the single contact, respectively.

Moreover, there has been conventionally known a relay that can mount either twin contacts or a single contact on a fixed contact piece and a movable contact piece (see Japanese Laid-open Patent Publication No. 2000-149748).

### SUMMARY

According to an aspect of the present invention, there is provided an electromagnetic relay including: an electromagnet; a twin contact set that includes first twin contacts provided on a first movable spring, and second twin contacts that are provided on a first fixed contact plate and disposed opposite to the first twin contacts; a single contact set that includes a first single contact provided on a second movable spring, and a second single contact that is provided on a second fixed contact plate and disposed opposite to the first single contact; and a card that moves in response to excitation or non-excitation of the electromagnet, and moves the first and the second movable springs simultaneously with the movement of the card.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1C are diagrams illustrating the schematic configuration of an electromagnetic relay 1 according to a present embodiment;

FIG. 2 is a diagram illustrating the schematic configuration of a fixing mold 2;

FIG. 3A is a diagram illustrating the schematic configuration of a movable spring 10;

FIG. 3B is a diagram illustrating the schematic configuration of a movable spring 20;

FIG. 3C is a side view of a pair of movable springs 10 and 20;

FIG. 3D is a diagram illustrating the schematic configuration of a movable terminal 17;

FIG. 4A is a diagram illustrating the schematic configuration of a fixed contact plate 9;

FIG. 4B is a diagram illustrating the schematic configuration of a fixed contact plate 21;

FIG. 5A is a diagram illustrating the schematic configuration of an iron core 7;

FIG. 5B is a diagram illustrating the schematic configuration of a coil terminal 12;

FIG. 5C is a diagram illustrating the schematic configuration of a return spring 11;

FIG. 6A is a sectional view of the electromagnetic relay 1 taken along a line B-B in FIG. 1B;

FIG. 6B is a diagram of the electromagnetic relay 1 as seen from above;

FIG. 7A is a diagram illustrating a non-operation state of the electromagnetic relay 1;

FIG. 7B is a diagram illustrating an operation state of the electromagnetic relay 1;

FIG. 8A is a diagram schematically illustrating the circuit configuration of the electromagnetic relay 1;

FIG. 8B is a time chart illustrating the operation of the electromagnetic relay 1;

FIG. 9A is a left side view of the electromagnetic relay 1 according to a first variation example;

FIG. 9B is a right side view of the electromagnetic relay 1 according to a first variation example;

FIG. 10A is a left side view of the electromagnetic relay 1 according to a second variation example;

FIG. 10B is a right side view of the electromagnetic relay 1 according to a second variation example;

FIG. 11A is a left side view of the electromagnetic relay 1 according to a third variation example; and

FIG. 11B is a right side view of the electromagnetic relay 1 according to a third variation example.

### DESCRIPTION OF EMBODIMENTS

A relay sometimes includes two or more contact sets each of which is composed of the fixed contact and the movable contact. In this case, the two contact sets have the same specifications. That is, when each of the fixed contact and the movable contact included in one contact set is the twin contacts, each of the fixed contact and the movable contact included in the other contact set is also the twin contacts. Alternatively, when each of the fixed contact and the movable contact included in one contact set is the single contact, each of the fixed contact and the movable contact included in the other contact set is also the single contact.

In this case, a high load and a low load cannot be handled with only a single relay at the same time. A single contact can handle the high load, but cannot handle the low load. On the other hand, the twin contacts can handle the low load, but cannot handle the high load.

A description will now be given of a present embodiment with reference to the drawings.

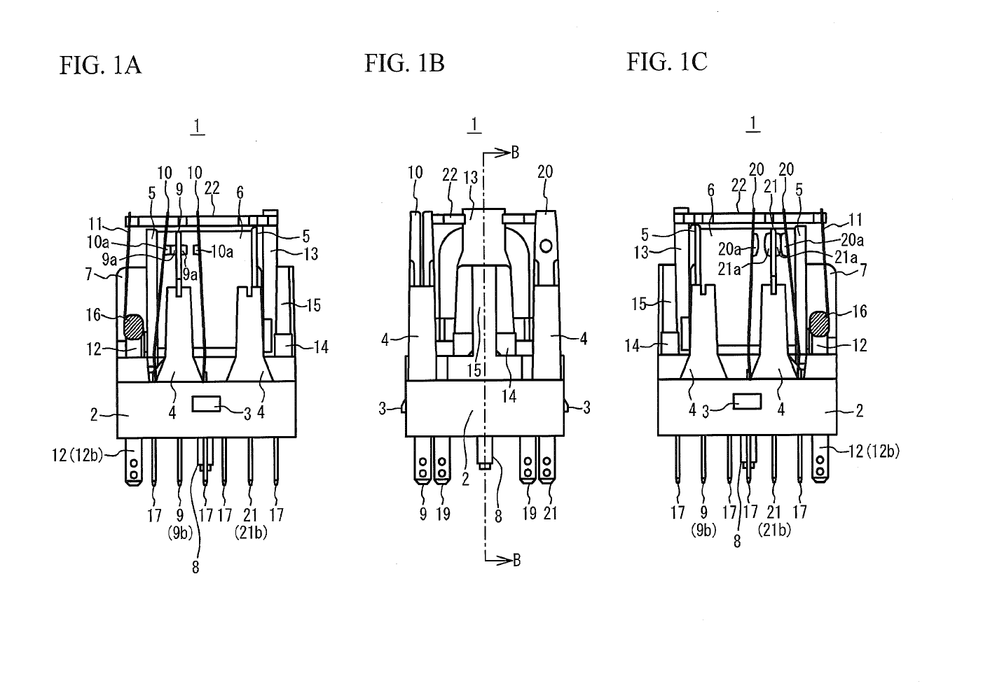

FIGS. 1A to 1C are diagrams illustrating the schematic configuration of an electromagnetic relay 1 according to a present embodiment. FIG. 1A illustrate a left side face of the electromagnetic relay 1. FIG. 1B illustrate a front face of the electromagnetic relay 1. FIG. 1C illustrate a right side face of the electromagnetic relay 1.

The electromagnetic relay 1 includes a fixing mold 2 corresponding to a frame, a spool 5, a coil 6, an iron core 7, movable springs 10 and 20, fixed contact plates 9 and 21, a return spring 11, a coil terminal 12, an armature 13, a hinge spring 14, a movable terminal 17 and a card 22. The movable springs 10 and 20 are plate springs, and the fixed contact plates 9 and 21 are metal such as brass.

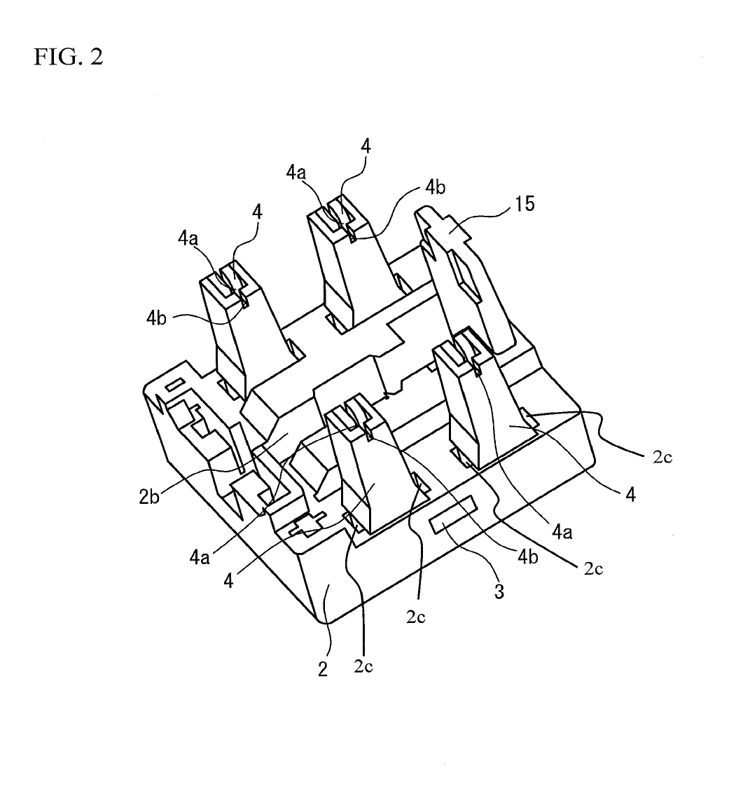

Protrusions 3 for attaching a cover, not shown, are formed on the left and the right side faces of the fixing mold 2. FIG. 2 illustrates the schematic configuration of the fixing mold 2. The fixing mold 2 is made of a resin or the like, and includes four projecting units 4 that can attach either the fixed contact plate 9 or 21. An insertion slot 4a for inserting the fixed contact plate 9 or 21 is formed on an upper part of each of the projecting units 4. Moreover, a groove 4b is formed on the upper part of each of the projecting units 4 so that a part of the fixed contact plate 9 or 21 contacts the upper part of each of the projecting units 4. Then, the fixing mold 2 includes a regulating unit 15 that extends upward and regulates the movement of the armature 13. Moreover, a groove 2b for placing the spool 5, the coil 6 and the iron core 7 which constitute an electromagnet is formed on the fixing mold 2. Here, a hole, a slot and a rib for mounting respective parts are properly formed on the fixing mold 2.

In FIG. 1A, the fixed contact plate 9 is inserted into one of the projecting units 4 (i.e., the projecting unit 4 of the left side). Then, a pair of movable springs 10 (i.e., two movable springs 10) are provided on both sides of the fixed contact plate 9 so as to be opposite to the fixed contact plate 9. In FIG. 1C, the fixed contact plate 21 is inserted into one of the projecting units 4 (i.e., the projecting unit 4 of the right side). Then, a pair of movable springs 20 (i.e., two movable springs 20) are provided on both sides of the fixed contact plate 21 so as to be opposite to the fixed contact plate 21. As illustrated in FIGS. 1A and 1C, upper ends of the movable springs 10 and 20 contact the card 22. Holes 2c for inserting the pair of movable springs 10 or 20 are formed on right and left sides of each of the projecting units 4 (see FIG. 2).

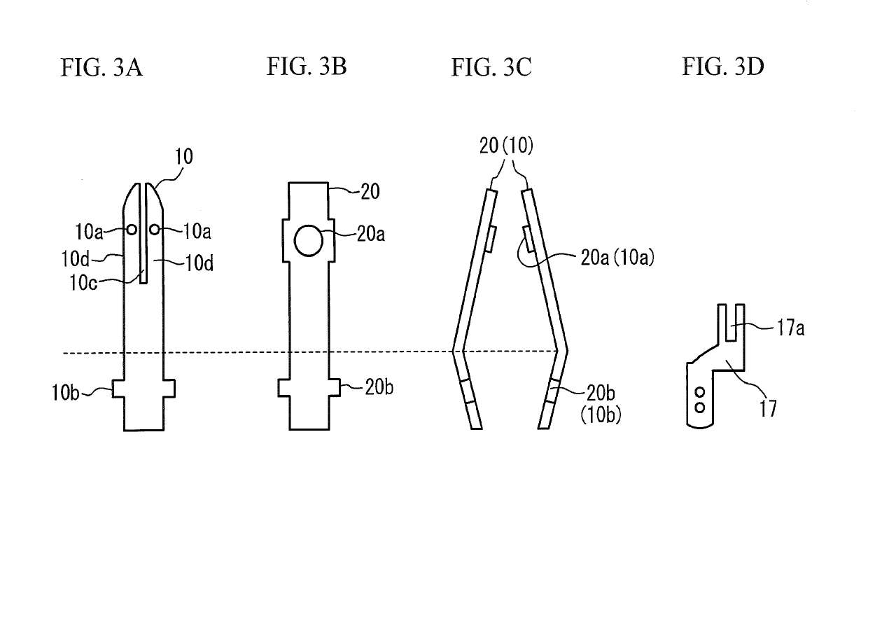

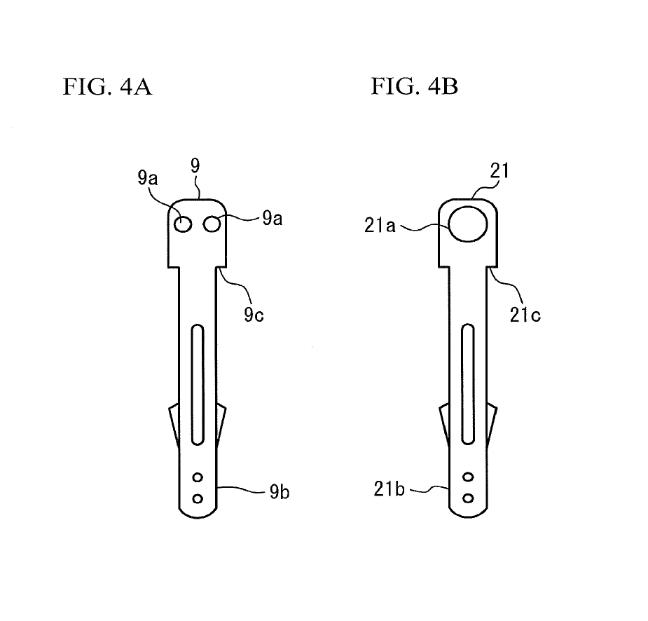

FIG. 3A illustrates the schematic configuration of the movable spring 10, and FIG. 3B illustrates the schematic configuration of the movable spring 20. FIG. 3C is a side view of the pair of movable springs 10 and 20. FIG. 3D illustrates the schematic configuration of the movable terminal 17. FIGS. 4A and 4B illustrate the fixed contact plates 9 and 21, respectively.

As illustrated in FIG. 3A, a cut 10c is formed near the upper end of the movable spring 10, and two spring elements 10d are formed. Contacts 10a (hereinafter, each contact thereof is also referred to as “a twin contact”) constituting twin contacts are provided on the respective spring elements 10d. The twin contacts 10a are contacts for handling a low load (e.g. a load of a control system which processes an electric current of 10 mA). Even if the twin contact 10a provided on one of the spring elements 10d and a fixed contact mentioned later becomes contact failure, contact with the fixed contact can be maintained by the twin contact 10a provided on the other one of the spring elements 10d. Therefore, in the case of the low load in which the contact failure between the contacts becomes a problem, the twin contacts 10a can secure reliability of the contact. Moreover, a stopper 10b that contacts the fixing mold 2 and regulates a limit location of the insertion of the movable spring 10 is formed near a lower end of the movable spring 10.

As illustrated in FIG. 3B, a single contact 20a is provided near the upper end of the movable spring 20. The single contact 20a is a contact for handling a high load (e.g. a load of a power supply system which processes an electric current of 5 A). Since the single contact 20a is larger than the movable spring 10, the single contact 20a prevents the contacts from being welded and being worn away at the time of the high load, and is excellent in the durability. Therefore, the single contact 20a can secure reliability of the contact in the case of the high load. Moreover, a stopper 20b that contacts the fixing mold 2 and regulates a limit position of the insertion of the movable spring 20 is formed near a lower end of the movable spring 20.

As illustrated in FIG. 3C, the movable springs 10 and 20 are bent at positions (i.e. positions illustrated by a dotted line) located slightly above the stoppers 10b and 20b so as to come close to the fixed contact plates 9 and 21, respectively.

The movable springs 10 and 20 are inserted from above the projecting units 4, but the movable terminal 17 of FIG. 3D is press-fitted from the bottom face of the fixing mold 2. At this time, each of the lower ends of the movable springs 10 and 20 is put between peripheral parts of a cut 17a of the movable terminal 17, and the movable springs 10 and 20 are electrically connected to the movable terminal 17.

The fixed contact plate 9 includes two twin contacts 9a that contact the twin contacts 10a of the movable spring 10 of FIG. 3A. As illustrated in FIG. 1A, the twin contacts 9a are formed on each of front and rear faces of the fixed contact plate 9. Therefore, the pair of movable springs 10 and the fixed contact plate 9 form two switches of a normally-on switch and a normally-off switch. The normally-on switch means a switch that is in an on-state by contacting one contact with another contact when no coil voltage is applied. The normally-off switch means a switch that is in an off-state by separating one contact from another contact when no coil voltage is applied. Thus, in the present embodiment, the two switches of the normally-on switch and the normally-off switch can be provided for one projecting unit 4. Here, only the pair of movable springs 10 and the fixed contact plate 9 constituting the normally-on switch, or only the pair of movable springs 10 and the fixed contact plate 9 constituting the normally-off switch may be provided for one projecting unit 4 according to a using way of the electromagnetic relay.

The fixed contact plate 21 of FIG. 4B includes a single contact 21a that contacts a single contact 20a of the movable spring 20 of FIG. 3B. As illustrated in FIG. 1C, the single contact 21a are formed on each of front and rear faces of the fixed contact plate 21. Therefore, the pair of movable springs 20 and the fixed contact plate 21 form two switches of a normally-on switch and a normally-off switch. Only the pair of movable springs 20 and the fixed contact plate 21 constituting the normally-on switch, or only the pair of movable springs 20 and the fixed contact plate 21 constituting the normally-off switch may be provided for one projecting unit 4.

Since the fixed contact plate 9 is formed integrally to a fixed terminal 9b from a position where the twin contact 9a is provided, the fixed terminal 9b is exposed from the bottom of the fixing mold 2 by inserting the fixed contact plate 9 from the projecting unit 4, as illustrated in FIG. 1A. In this case, a jaw part 9c of the fixed contact plate 9 contacts the groove 4b of the projecting unit 4. Similarly, since the fixed contact plate 21 is formed integrally to a fixed terminal 21b from a position where the single contact 21a is provided, the fixed terminal 21b is exposed from the bottom of the fixing mold 2 by inserting the fixed contact plate 21 from the projecting unit 4, as illustrated in FIG. 1C. In this case, a jaw part 21c of the fixed contact plate 21 contacts the groove 4b of the projecting unit 4.

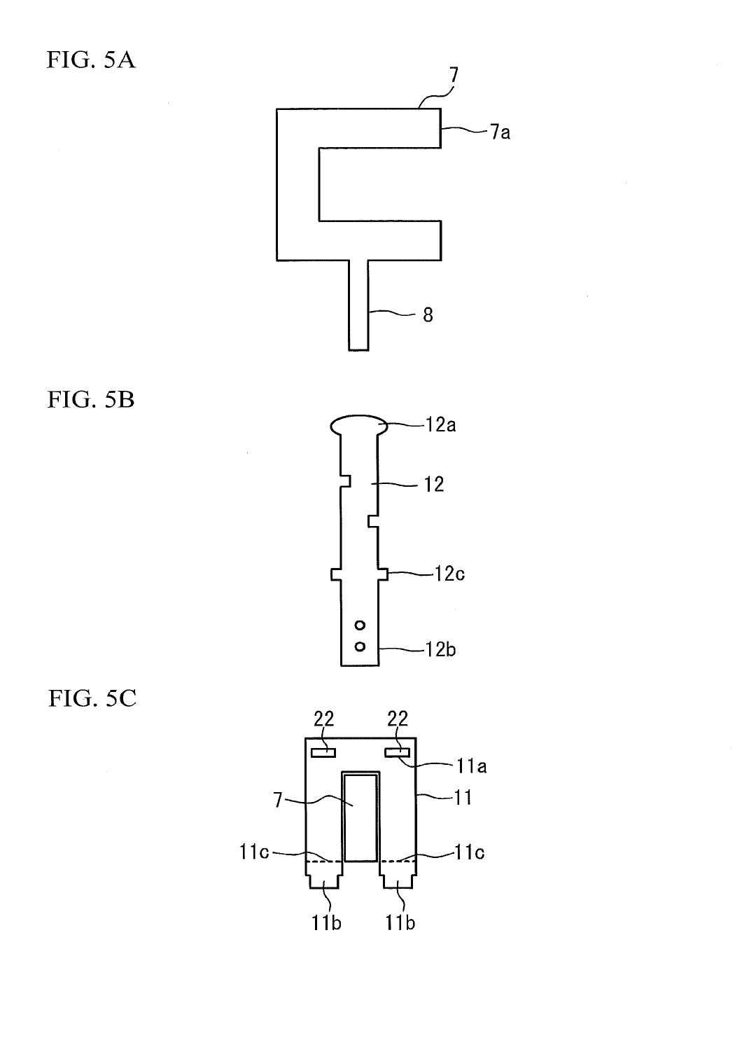

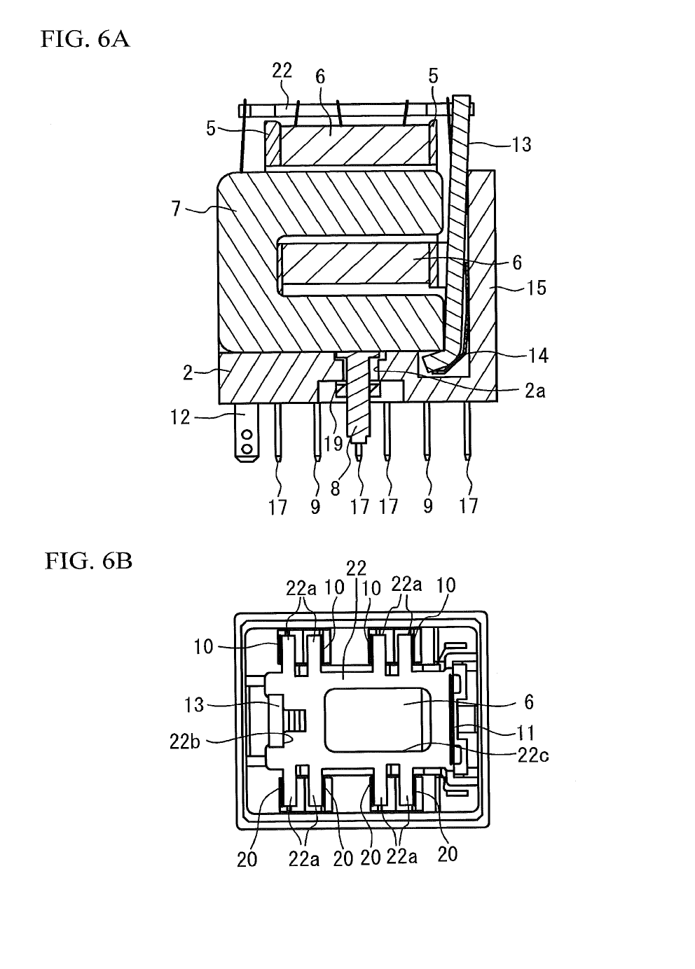

FIG. 5A is a diagram illustrating the schematic configuration of the iron core 7. FIG. 5B is a diagram illustrating the schematic configuration of the coil terminal 12. FIG. 5C is a diagram illustrating the schematic configuration of the return spring 11. FIG. 6A is a sectional view of the electromagnetic relay 1 taken along a line B-B in FIG. 1B. FIG. 6B is a diagram of the electromagnetic relay 1 as seen from above. In FIG. 6B, two pairs of the movable springs 10 and two pairs of the movable springs 20 are provided.

As illustrated in FIGS. 5A and 6A, the iron core 7 is almost a U-shape, and one end of the iron core 7 (i.e., an end portion of an upper side of the iron core 7) is inserted into a central portion of the spool 5. A screw unit 8 extending vertically downward is provided on the iron core 7. The screw unit 8 is exposed to the outside via a through-hole 2a provided on the center of the fixing mold 2. The screw unit 8 exposed to the outside is fixed to the fixing mold 2 by a screw 19. That is, the iron core 7 is fixed to the fixing mold 2.

The coil terminal 12 illustrated in FIG. 5B includes a head portion 12a, a terminal portion 12b and a stopper 12c. The coil terminal 12 is inserted into a through-hole, not shown, of the fixing mold 2 from above the projecting unit 4. At this time, the terminal portion 12b of the coil terminal 12 is exposed from the fixing mold 2, as illustrated in FIGS. 1A and 1C. Moreover, the stopper 12c that regulates a limit position of the insertion of the coil terminal 12 is formed on the coil terminal 12. In the coil terminal 12, the coil 6 is wound on the head portion 12a, and is fixed thereto by a solder 16. Thereby, the coil terminal 12 is electrically connected to the coil 6.

The return spring 11 illustrated in FIG. 5C has almost a U-shape so as to cover the iron core 7. Two through-holes 11a in which a part of card 22 is fitted are formed on an upper part of the return spring 11. Thereby, the return spring 11 is coupled with the card 22, and pushes the card 22 toward the armature 13. Moreover, the return spring 11 includes fixed portions 11b for fixing the return spring 11 to the fixing mold 2. In the return spring 11, leg portions 11c are bent at a position of a dotted line to push the card 22 toward the armature 13.

As illustrated in FIGS. 6A and 1A, the armature 13 is provided between the iron core 7 and the regulating unit 15, and the hinge spring 14 is provided between the armature 13 and the regulating unit 15. As illustrated in FIGS. 6A and 6B, an upper end of the armature 13 is fixed to the card 22.

As illustrated in FIG. 6B, the card 22 is formed with almost a rectangular flat plate, and an opening 22c which exposes the coil 6 is formed on the center of the card 22. A concave portion 22b for fixing the armature 13 is formed on a rear face side (i.e., a left side of FIG. 6B) of the card 22. In addition, in the card 22, two pairs of projections 22a are projected from each of the right and the left side faces of the flat plate. A space is formed between each pair of projections 22a. The movable springs 10 contact the respective outsides from the spaces of the two pairs of projections 22a on the right side face (i.e., an upper side of FIG. 6B). The movable springs 20 contact the respective outsides from the spaces of the two pairs of projections 22a on the left side face (i.e., a lower side of FIG. 6B).

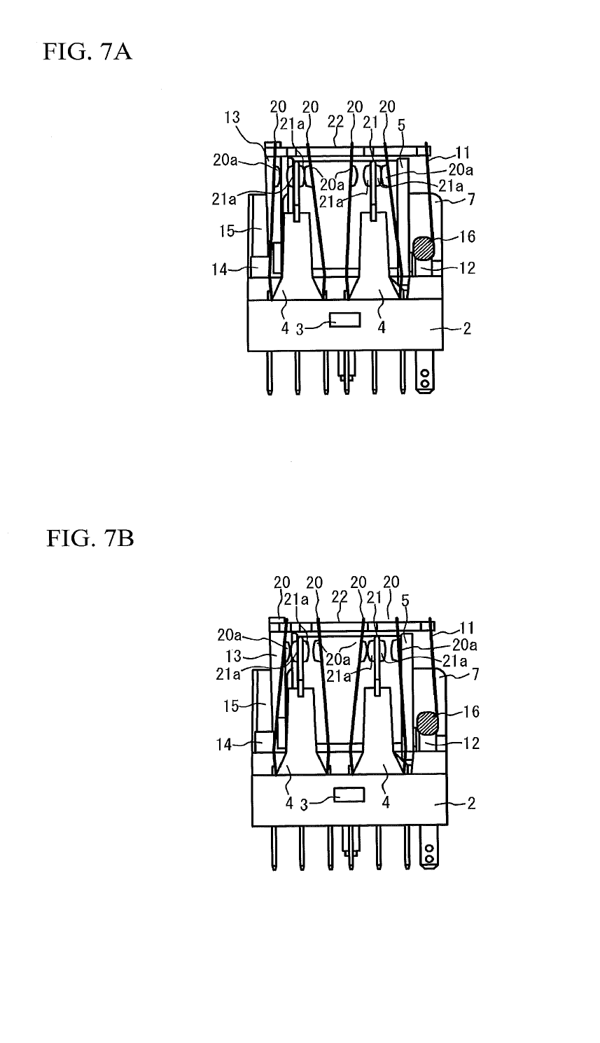

FIG. 7A is a diagram illustrating a non-operation state of the electromagnetic relay 1. FIG. 7B is a diagram illustrating an operation state of the electromagnetic relay 1. In the states illustrated in FIGS. 7A and 7B, the fixed contact plate 21 is provided on each of two projecting units 4. Here, also when the movable springs 10 and the fixed contact plates 9 are provided on the projecting units 4, the operation like FIGS. 7A and 7B is performed.

First, in the non-operation state of FIG. 7A (i.e., in a case where an electromagnet is not excited), the iron core 7 does not attract the armature 13 by an electromagnetic force, and the return spring 11 pushes the card 22 in a left direction of FIG. 7A. Thereby, the armature 13 is pushed in the left direction of FIG. 7A by the card 22, and contacts the regulating unit 15. Moreover, the respective movable springs 20 in which the upper ends contacts the card 22 are moved in the left direction of FIG. 7A. Thereby, the contact 20a on the movable spring 20, in the pair of movable springs 20, located on a right side of the fixed contact plate 21 contacts the contact 21a of the fixed contact plate 21, and the contact 20a on the movable spring 20 located on a left side of the fixed contact plate 21 does not contact the contact 21a.

Next, in the operation state of FIG. 7B, a voltage is applied to the coil 6 and the electromagnet is excited. Therefore, the armature 13 is attracted to the iron core 7 by the electromagnetic force, and moves in a right direction of FIG. 7B from the state of FIG. 7A. Thereby, the armature 13 pushes the card 22 in the right direction of FIG. 7B. At this time, the movable springs 20 in which the upper ends contacts the card 22 are moved in the right direction of FIG. 7B. Thereby, the contact 20a on the movable spring 20, in the pair of movable springs 20, located on the left side of the fixed contact plate 21 contacts the contact 21a of the fixed contact plate 21, and a contact state between the contact 21a and the contact 20a on the movable spring 20 located on the right side of the fixed contact plate 21 is released.

Thus, when the voltage is not applied to the coil 6, the electromagnetic relay 1 becomes the non-operation state of FIG. 7A. When the voltage is applied to the coil 6, the electromagnetic relay 1 becomes the operation state of FIG. 7B. When on/off of the voltage to be applied to the coil 6 is switched, the operation state of FIG. 7B and the non-operation state of FIG. 7A are alternately switched.

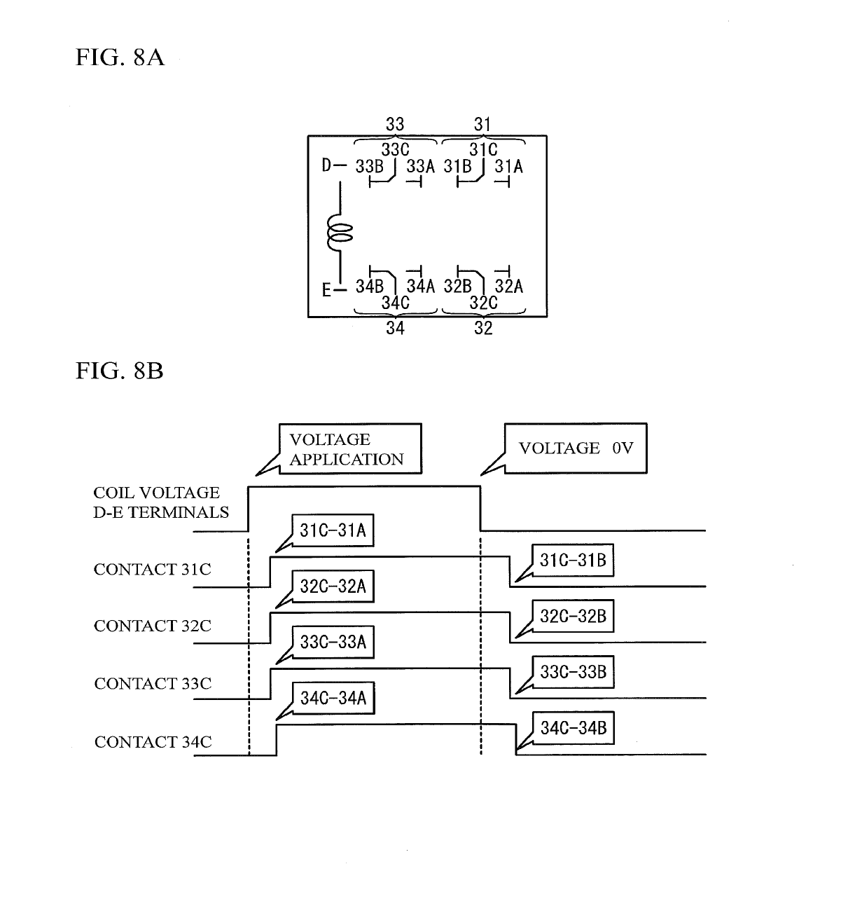

FIG. 8A is a diagram schematically illustrating the circuit configuration of the electromagnetic relay 1. FIG. 8B is a time chart illustrating the operation of the electromagnetic relay 1.

As illustrated in FIG. 8A, the electromagnetic relay 1 includes four switch sets 31 to 34, and coil terminals D and E. Here, the number of switch sets included in the electromagnetic relay 1 is not limited to four.

Each of the coil terminals D and E corresponds to the above-mentioned coil terminals 12. Each of the switch sets 31 to 34 has three contacts composed of two movable contacts and a single fixed contact, and forms the two switches of the normally-on switch and the normally-off switch. For example, the switch set 31 includes two movable contacts 31A and 31B, and a single fixed contact 31c, constitutes the normally-on switch by the contacts 31C and 31B, and constitutes the normally-off switch by the contacts 31C and 31A.

Each of the switch sets 31 to 34 corresponds to any one of a set of the twin contacts 10a on the pair of movable springs 10 and the twin contacts 9a on the fixed contact plate 9 disposed between the movable springs 10, or a set of the single contacts 20a on the pair of movable springs 20 and the single contacts 21a on the fixed contact plate 21 disposed between the movable springs 20.

When the switch set 31 corresponds to the set of the twin contacts 10a on the pair of movable springs 10 and the twin contacts 9a on the fixed contact plate 9 disposed between the movable springs 10, for example, the contact 31c corresponds to the twin contacts 9a on the fixed contact plate 9, and each of the contacts 31A and 31B corresponds to the twin contacts 10a on the pair of movable springs 10. When the switch set 32 corresponds to the set of the single contacts 20a on the pair of movable springs 20 and the single contacts 21a on the fixed contact plate 21 disposed between the movable springs 20, for example, the contact 32C corresponds to the single contacts 21a on the fixed contact plate 21, and each of the contacts 31A and 31B corresponds to the single contacts 20a on the pair of movable springs 20.

In a state where the voltage is not applied between the coil terminals D and E of FIG. 8B, the contacts 31C, 32C, 33C and 34C contact the contacts 31B, 32B, 33B and 34B, respectively. When the voltage is applied between the coil terminals D and E (i.e., the coil terminals 12), as illustrated in FIG. 8B, the armature is attracted to the electromagnet, the card is moved and hence the movable springs are moved according to the movement of the card. Therefore, after a constant time lag, contacts to be connected to the contacts 31C, 32C, 33C and 34C are simultaneously switched from the contacts 31B, 32B, 33B and 34B to the contacts 31A, 32A, 33A and 34A, respectively. When the voltage to be applied between the coil terminals D and E becomes 0V, the card moves by a biasing force of the return spring, and after a constant time lag, the contacts to be connected to the contacts 31C, 32C, 33C and 34C are simultaneously switched from the contacts 31A, 32A, 33A and 34A to the contacts 31B, 32B, 33B and 34B, respectively. Thereby, the plurality of switches can be switched simultaneously, and it is possible to handle a plurality of loads at the same time by forming contact configuration of each switch so as to be suited for a desired load. For example, when the switch sets 31 to 34 include the pair of movable springs 10 and the fixed contact plate 9 disposed between the movable springs 10, and the pair of movable springs 20 and the fixed contact plate 21 disposed between the movable springs 20, it is possible to handle the high load and the low load at the same time.

The electromagnetic relay 1 of FIGS. 1A and 1C has a twin contact set that includes the twin contacts 10a on the pair of movable springs 10 and the twin contacts 9a on the fixed contact plate 9 disposed between the movable springs 10, and a single contact set that includes the single contacts 20a on the pair of movable springs 20 and the single contacts 21a on the fixed contact plate 21 disposed between the movable springs 20. However, each of the number of twin contact sets and the number of single contact sets is not limited to one.

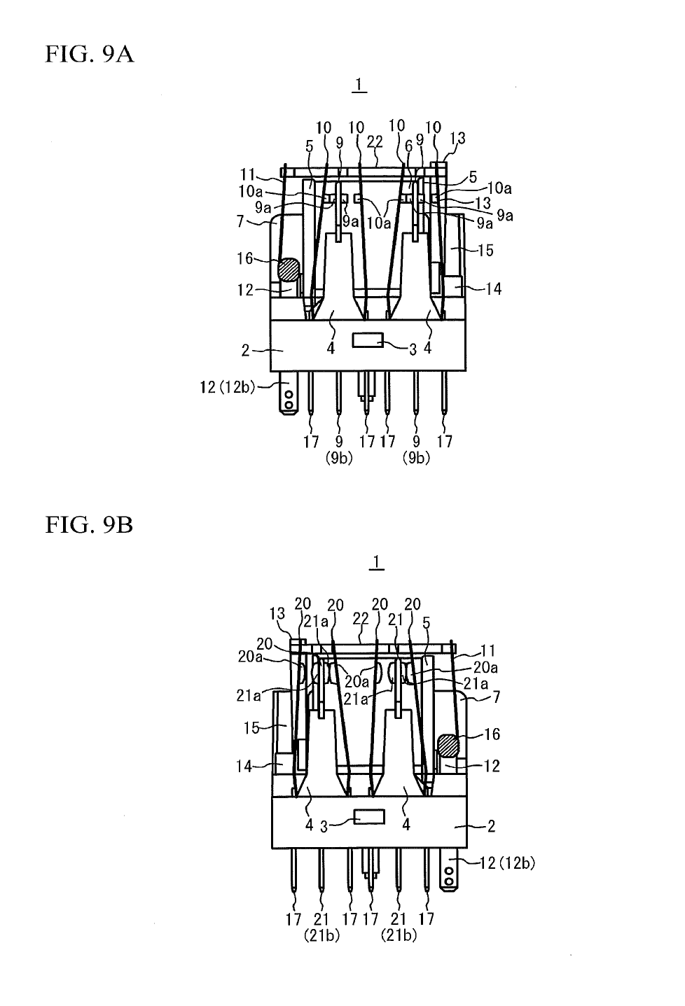

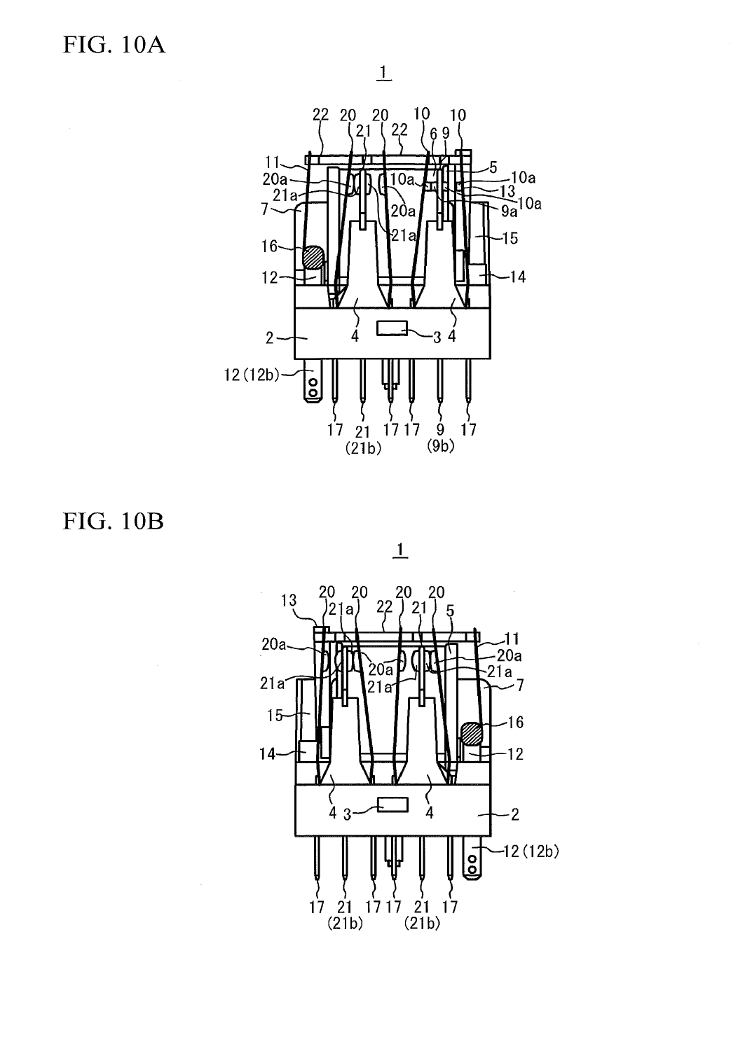

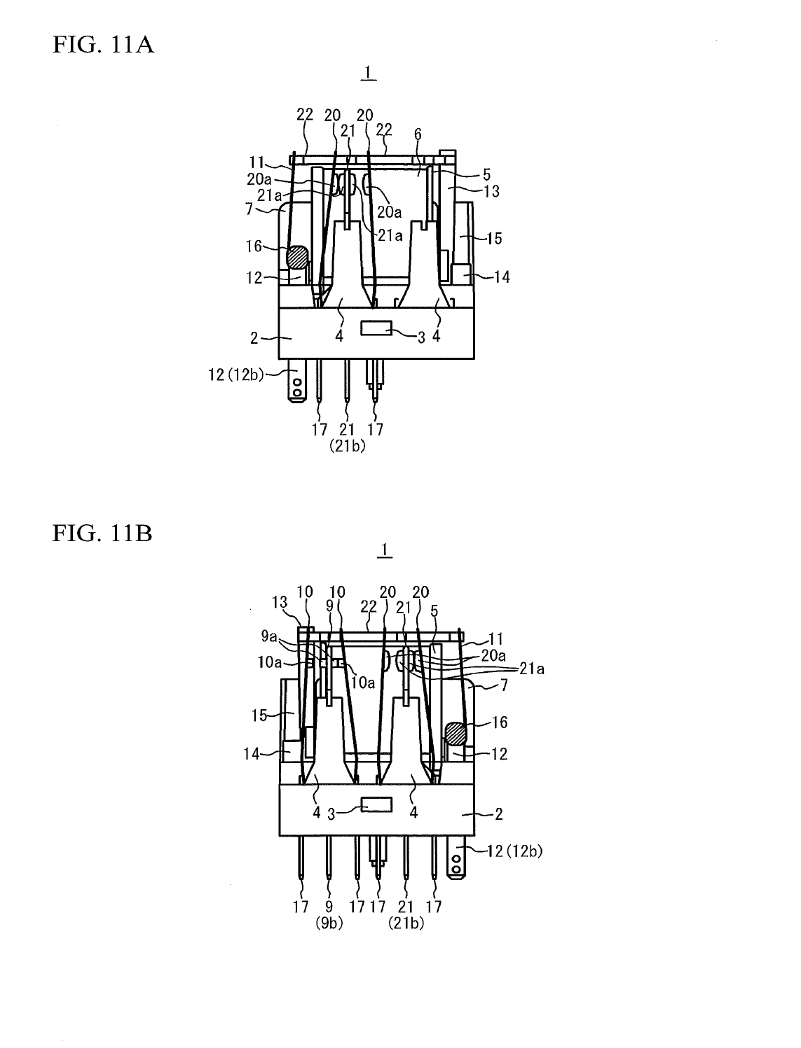

For example, the electromagnetic relay 1 may include two twin contact sets and two single contact sets, as illustrated in FIGS. 9A and 9B. Moreover, the electromagnetic relay 1 may include one twin contact set and three single contact sets, as illustrated in FIGS. 10A and 10B. On the contrary, the electromagnetic relay 1 may include three twin contact sets and one single contact set. In addition, the electromagnetic relay 1 may include one twin contact set and two single contact sets, as illustrated in FIGS. 11A and 11B. On the contrary, the electromagnetic relay 1 may include two twin contact sets and one single contact set. In this case, the fixed contact plate 9 or 21 is not provided on one of the projecting units 4.

Moreover, the number of the projecting units 4 included in the fixing mold 2 is not limited to four. The fixing mold 2 needs to include at least two projecting units 4. Although in the present embodiment, the plurality of projecting units 4 are disposed so as to be opposite to the right and the left side faces of the electromagnet, the plurality of projecting units 4 may be disposed so as to be opposite to only one of the right and the left side faces of the electromagnet.

According to the present embodiment, the electromagnetic relay 1 includes: the electromagnet composed of the spool 5, the coil 6 and the iron core 7; the twin contact set that includes the twin contacts 10a provided on the movable spring 10, and the twin contacts 9a that are provided on the fixed contact plate 9 and disposed opposite to the twin contacts 10a; the single contact set that includes the single contact 20a provided on the movable spring 20, and the single contact 21a that is provided on the fixed contact plate 21 and disposed opposite to the single contact 20a; and the card 22 that moves in response to the excitation or non-excitation of the electromagnet, and moves the movable springs 10 and 20 simultaneously with the movement of the card 22. Therefore, the electromagnetic relay 1 can simultaneously handle the high load (e.g. the load of the power supply system which processes the electric current of 5 A) and the low load (e.g. the load of the control system which processes the electric current of 10 mA), and can secure reliability of the contact.

Moreover, the electromagnetic relay 1 includes: the armature 13 that adjoins one end of the electromagnet in a longitudinal direction, and is attracted by the electromagnetic force of the electromagnet; the card 22 that is fixed to the armature 13 and includes a plurality of pairs of projections 22a extending toward the right and the left side faces of the electromagnet; and the return spring 11 that is opposite to another end of the electromagnet in the longitudinal direction, is coupled with the card 22, and biases the card 22 toward the armature 13; wherein the upper ends of the pair of movable springs 10 and the pair of movable springs 20 contact the plurality of pairs of projections 22a, and follow the movement of the card 22. Therefore, the twin contacts 10a on the pair of movable springs 10 and the single contacts 20a on the pair of movable springs 20 can be simultaneously turned on or off in accordance with the movement of the card 22.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An electromagnetic relay comprising:
an electromagnet;
a twin contact set that includes first twin contacts provided on a first movable spring, and second twin contacts that are provided on a first fixed contact plate and disposed opposite to the first twin contacts;
a single contact set that includes a first single contact provided on a second movable spring, and a second single contact that is provided on a second fixed contact plate and disposed opposite to the first single contact; and
a card that moves in response to excitation or non-excitation of the electromagnet, and moves the first and the second movable springs simultaneously with the movement of the card.

2. The electromagnetic relay as claimed in claim 1, further comprising:
a pair of first movable springs disposed to put the first fixed contact plate therebetween, each of the first movable springs including the first twin contacts; and
a pair of second movable springs disposed to put the second fixed contact plate therebetween, each of the second movable springs including the first single contact;
wherein the first twin contacts on the pair of first movable springs and the second twin contacts on the first fixed contact plate form a first normally-on switch and a first normally-off switch,
first single contacts on the pair of second movable springs and second single contacts on the second fixed contact plate form a second normally-on switch and a second normally-off switch, and
the first normally-off switch and the second normally-off switch are simultaneously turned on in response to turning-on of the electromagnet, and the first normally-on switch and the second normally-on switch are simultaneously turned on in response to turning-off of the electromagnet.

3. The electromagnetic relay as claimed in claim 2, further comprising:
an armature that adjoins one end of the electromagnet in a longitudinal direction, and is attracted by an electromagnetic force of the electromagnet;
a return spring that is opposite to another end of the electromagnet in the longitudinal direction, is coupled with the card, and biases the card toward the armature;
wherein the card is fixed to the armature and includes a plurality of pairs of projections extending toward right and left side faces of the electromagnet, and
the pair of first movable springs and the pair of second movable springs contact the plurality of pairs of projections, and follow the movement of the card.

4. The electromagnetic relay as claimed in claim 1, further comprising:
a fixing mold that mounts the electromagnet, and includes a projecting unit that mounts any one of the first fixed contact plate and the second fixed contact plate;
wherein the projecting unit includes an insertion slot for inserting any one of the first fixed contact plate and the second fixed contact plate, and a groove for fixing any one of the first fixed contact plate and the second fixed contact plate.

5. The electromagnetic relay as claimed in claim 4, wherein
The fixing mole includes holes for inserting the first movable spring or the second movable spring that are formed on right and left sides of the projecting unit.

6. The electromagnetic relay as claimed in claim 1, wherein
the first movable spring includes spring elements on which the first twin contacts are provided, respectively, and a first stopper that regulates a limit position of insertion of the first movable spring;
wherein a cut is formed between the spring elements, and the first movable spring is bent at a position located slightly above the first stopper so as to come close to the first fixed contact plate.

7. The electromagnetic relay as claimed in claim 1, wherein
the first single contact is provided on an upper portion of the second movable spring, a second stopper that regulates a limit position of insertion of the second movable spring is formed on a lower portion of the second movable spring, and the second movable spring is bent at a position located slightly above the second stopper so as to come close to the second fixed contact plate.
